(19) United States
(12) Patent Application Publication
(10) Pub. No.: US 2026/0213238 A1
(43) Pub. Date: Jul. 23, 2026

(54) METHOD FOR MANUFACTURING POLYMER ELECTROLYTE MEMBRANE

(71) Applicant: KOLON INDUSTRIES, INC., Seoul (KR)

(72) Inventors: Sung Hyun YUN, Seoul (KR); Jung Hwa PARK, Seoul (KR); Dong Hoon LEE, Seoul (KR); Kum Suck SONG, Seoul (KR); Hye Song LEE, Seoul (KR)

(21) Appl. No.: 19/139,899

(22) PCT Filed: Jan. 31, 2023
(86) PCT No.: PCT/KR2023/001376

§ 371 Date: Jun. 17, 2025

(30) Foreign Application Priority Data
Mar. 17, 2022 (KR) 10-2022-0033318

(51) Int. Cl. H01M 8/1004; H01M 8/10; H01M 8/1041; H01M 8/1058; H01M 8/1086

(52) U.S. Cl. CPC H01M 8/1004; H01M 8/1055; H01M 8/1058; H01M 8/1086; H01M 2008/1095

(57) ABSTRACT

The present disclosure relates to a method for manufacturing a polymer electrolyte membrane and, specifically, to a method for manufacturing a polymer electrolyte membrane, the method comprising the steps of: preparing a composition for printing, containing a functional additive; and forming a digital print layer by printing the composition for printing on one side or both sides of the polymer electrolyte membrane by using a digital printing device.

### TECHNICAL FIELD

The present disclosure relates to a method for manufacturing a polymer electrolyte membrane and, more specifically, to a method for manufacturing a polymer electrolyte membrane by using a digital printing technique.

### BACKGROUND ART

A fuel cell is a cell that directly converts chemical energy generated by the oxidation of fuel into electrical energy, and is attracting attention as a next-generation energy source due to its high energy efficiency and environmentally friendly characteristics with low pollutant emissions.

A fuel cell generally has a structure in which an anode and a cathode are respectively formed on both sides with an electrolyte membrane therebetween, and such a structure is referred to as a Membrane-Electrode Assembly (MEA).

Among fuel cells, a Polymer Electrolyte Membrane Fuel Cell (PEMFC) is attracting attention as a power source for portable, automotive, and home applications due to advantages such as a low operating temperature of less than 100° C., fast start-up and response characteristics, and excellent durability. A representative example of such a polymer electrolyte membrane fuel cell is a Proton Exchange Membrane Fuel Cell (PEMFC) that uses hydrogen gas as fuel.

To summarize the reactions occurring in a polymer electrolyte membrane fuel cell, first, when a fuel such as hydrogen gas is supplied to the anode, hydrogen ions (H⁺) and electrons (e) are produced at the anode through the oxidation reaction of hydrogen. The produced hydrogen ions (H⁺) are transferred to the cathode through the polymer electrolyte membrane and the produced electrons (e) are transferred to the cathode through an external circuit. At the cathode, oxygen is supplied and oxygen combines with hydrogen ions (H⁺) and electrons (e), whereby water is produced through the reduction reaction of oxygen.

Meanwhile, in order to realize commercialization of polymer electrolyte membrane fuel cells, there still exist many technical barriers to be overcome, and essential improvement factors are realization of high performance, long lifespan, and cost reduction. The component that most significantly affects this is the membrane-electrode assembly, among which the polymer electrolyte membrane is one of the key factors that has the greatest impact on the performance and cost of the MEA.

Polymer electrolyte membranes require both high ion conductivity and excellent durability. In particular, during long-term operation of fuel cells, degradation of the fuel cells occurs due to thinning of electrolyte membranes and pin-hole formation caused by weak chemical durability of the polymer electrolyte membranes.

Radicals that are produced during the operation of fuel cells are known to be the main cause of such degradation of polymer electrolyte membranes. For example, during the oxygen reduction reaction at a cathode, hydrogen peroxide (H₂O₂) is produced due to an unwanted reaction, and hydroperoxyl radical (HO₂·) and/or hydroxyl radical (·OH) may be produced from this hydrogen peroxide. Further, when oxygen molecules in the air that is supplied to the cathode pass through a polymer electrolyte membrane and reach the anode, hydrogen peroxide is also produced at the anode, which may cause hydroperoxyl radicals and/or hydroxyl radicals. These radicals cause degradation of the ionomer (for example, a polymer having a sulfonic acid group) contained in the polymer electrolyte membrane, thereby reducing the ionic conductivity of the electrolyte membrane.

As a technique for alleviating such chemical degradation of electrolyte membranes, a method of adding various types of antioxidants to electrolyte membranes has been proposed. These antioxidants may be used either individually as primary antioxidants having a radical scavenging function and secondary antioxidants having hydrogen peroxide decomposition functions, or in combination with each other.

However, such antioxidants generally have low proton conductivity and have the problem that when they are mixed with a polymer electrolyte solution and cast together to form a membrane, particle agglomeration hinders proton transport and this leads to a decrease in the proton conductivity of polymer electrolyte membranes. Moreover, although it is desirable that an antioxidant reaction occurs in a catalyst layer, which is the origin of radical production, methods of the related art have difficulty in increasing the antioxidant content in regions adjacent to the catalyst layer or in forming an antioxidant region in fine patterned shapes or applying it uniformly as needed.

### DISCLOSURE

### Technical Problem

An objective of the present disclosure is to provide a method for manufacturing a polymer electrolyte membrane, the method being able to form a functional additive layer such as an antioxidant on the surface of a polymer electrolyte membrane adjacent to an electrode catalyst layer, and being able to micropattern a functional additive layer or adjust the application amount thereof as needed.

### Technical Solution

The inventors were able to achieve the present disclosure by attaining the objectives described above using a digital printing technique.

Therefore, according to an aspect of the present disclosure, there is provided a method for manufacturing a polymer electrolyte membrane that includes: preparing a composition for printing, containing a functional additive;

and forming a digital print layer by printing the composition for printing on one side or both sides of the polymer electrolyte membrane by using a digital printing device.

According to an embodiment, the functional additive may be an antioxidant removing peroxides or radicals.

According to an embodiment, the antioxidant may be at least one selected from a group consisting of transition metals, noble metals, ions thereof, salts thereof, oxides thereof, nitrides thereof, and complexes thereof.

According to an embodiment, the antioxidant may include at least one or more transition metals selected from a group consisting of cerium (Ce), manganese (Mn), tungsten (W), cobalt (Co), vanadium (V), nickel (Ni), chromium (Cr), zirconium (Zr), yttrium (Y), iridium (Ir), iron (Fe), titanium (Ti), molybdenum (Mo), lanthanum (La), and neodymium (Nd).

According to an embodiment, the functional additive may be contained at a concentration of 0.1 to 20 wt % in the composition for printing on the basis of a total weight of the composition.

According to an embodiment, the composition for printing may further contain a solvent, and the method may further include drying after forming the digital print layer

According to an embodiment, the solvent may be a mixed solvent comprising two or more types of alcohols.

According to an embodiment, the solvent may be a mixed solvent in which propyl alcohol and ethanol are mixed at a weight ratio of 6:4 to 2:8.

According to an embodiment, the digital printing device may include a printer selected from a group consisting of an inkjet printer, a laser printer, an aerosol printer, and a thermal transfer or sublimation printer, and the composition for printing may be printed by the printer.

According to an embodiment, the manufacturing method may further include: designing a pattern image of the digital print layer using computer software; and transmitting the pattern image to a printer, wherein the composition for printing may be printed on the polymer electrolyte membrane in a pattern corresponding to the pattern image.

According to an embodiment, the designing of a pattern image of the digital print layer may further include setting resolution of the pattern image, and a printing amount of the composition for printing may be determined in accordance with the resolution.

According to an embodiment, the polymer electrolyte membrane may be a reinforced composite membrane comprising a porous support and an ion conductor.

According to another aspect, there is provided a method for manufacturing a membrane-electrode assembly, the method comprising bringing the polymer electrolyte membrane manufactured in accordance with the method described above into contact with an electrode such that the digital print layer of the polymer electrolyte membrane faces the electrode.

### Advantageous Effects

According t disclosure, instead of manufacturing a polymer electrolyte membrane by mixing a functional additive such as an antioxidant with an ion conductor, it is possible to directly form the functional additive as a digital print layer on the surface of the polymer electrolyte membrane, and accordingly, it is possible to achieve excellent functionality even with a smaller amount of functional additive compared to the related art. Therefore, it is possible to maintain the performance of a fuel cell over a long period of time without chemical degradation of an electrolyte membrane and/or an electrode caused by hydrogen peroxides or radicals produced during operation of a fuel cell, and to significantly improve its durability.

Further, according to the present disclosure, not only it is possible to form the digital print layer on the entire surface of the polymer electrolyte membrane, but also, by using a digital image, it is possible to easily and quickly micropattern a functional additive layer into various fine shapes, such as a flow channel shape or a dot shape, as needed, thereby enabling fine structural control with excellent quality. Further, since the application amount of the digital print layer can be controlled on the basis of image resolution, it is possible to easily and accurately adjust the content of the additive. Further, it becomes possible to easily produce polymer electrolyte membranes with different additive contents by using the same polymer electrolyte membrane and composition for printing and adjusting only the image resolution without newly manufacturing a polymer electrolyte membrane every time, depending on the required additive content.

### DESCRIPTION OF DRAWINGS

FIG. 1 is a schematic diagram schematically illustrating a polymer electrolyte membrane in the form of a reinforced composite membrane, in which (a) to (c) are schematic diagrams of polymer electrolyte membranes according to the related art, and (d) and (e) are schematic diagrams of polymer electrolyte membranes according to an embodiment of the present disclosure.

FIG. 2 is a cross-sectional view schematically illustrating a membrane-electrode assembly according to an embodiment of the present disclosure.

FIG. 3 is a schematic diagram illustrating an overall configuration of a fuel cell according to an embodiment of the present disclosure.

FIG. 4 exemplarily shows a printing pattern of a digital print layer according to the present disclosure.

FIG. 5 is a photograph showing a digital print layer manufactured in accordance with an embodiment of the present disclosure.

### BEST MODE

Hereafter, embodiments of the present disclosure will be described in such that those skilled in the art can easily accomplish the present disclosure. However, the present disclosure may be modified in various different ways and is not limited to the embodiments described herein.

In the drawings, the thicknesses are exaggerated for clarity in illustrating various layers and regions, and throughout the specification, like parts are designated with the same reference numerals. When an element such as a layer, a film, a region, and a plate is “on” another component, it can be directly on the other element or intervening elements may be present therebetween. On the other hand, when an element is “directly on” another component, there is no object therebetween.

The term “comprise” as used in the present specification is used to list materials, compositions, devices, and methods useful in the present disclosure and is not intended to be limited to the listed examples.

Hereafter, a method for manufacturing a polymer electrolyte membrane according to an embodiment is described with reference to drawings.

Like general polymer electrolyte membranes, the polymer electrolyte membrane according to the present disclosure may be in any form, such as a single membrane formed by casting an ion conductor having ion conductivity into a mold, or a reinforced composite membrane including a composite material manufactured by immersing a porous support in a dispersion in which an ion conductor is dispersed.

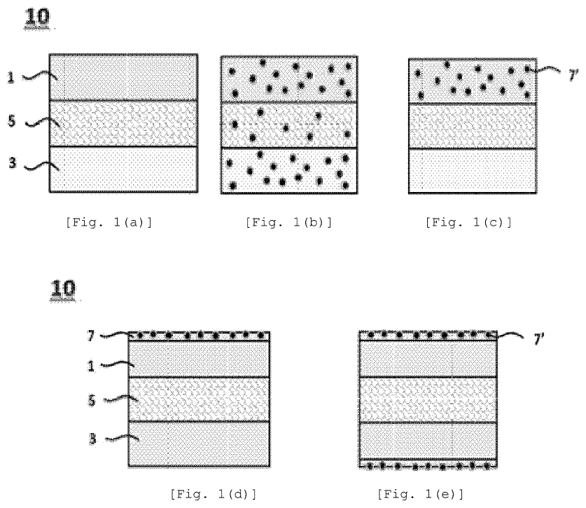

FIG. 1 is a schematic diagram schematically illustrating a polymer electrolyte membrane in the form of a reinforced composite membrane, in which (a) to (c) are schematic diagrams of polymer electrolyte membranes according to the related art, and (d) and (e) are schematic diagrams of polymer electrolyte membranes according to an embodiment of the present disclosure.

A porous support 5 serves to enhance the mechanical strength of a reinforced composite membrane 10 and to improve dimensional stability by suppressing volume expansion caused by moisture. Porous supports commonly used in the art may be used, or the porous support may be produced by chemically curing nanofibers of a polymer precursor, which are produced by electrospinning a solution containing a polymer precursor for forming a porous support.

The porous support 5 preferably includes a polymer that exhibits excellent chemical resistance because it is insoluble in common organic solvents, that facilitates the filling process of ion conductors within the pores of the porous support, and that has excellent heat resistance without risk of deformation due to moisture in high-humidity environments. The polymer used may be nylon, polyvinylidene fluoride (PVDF), polyphenylene sulfide (PPS), polyether ether ketone (PEEK), polylactic acid (PLA), polyimide (PI), polybenzoxazole (PBO), polybenzimidazole (PBI), polyamideimide (PAI), polyethylene terephthalate (PET), polyethylene (PE), polytetrafluoroethylene (PTFE), polypropylene (PP), their copolymers, or their mixtures, among which polyimide or polytetrafluoroethylene, which have superior heat resistance, chemical resistance, and dimensional stability, are preferable.

In an embodiment, the thickness of the porous support 5 may be from 1 to 100 μm, for example, from 1 to 75 μm, preferably from 1 to 50 μm, and more preferably from 3 to 40 μm. When the thickness of the porous support 5 is less than 1 μm, the physical and mechanical properties of a reinforced composite membrane may not be sufficiently secured and this may raise concerns about reduced durability and dimensional stability. When it exceeds 75 μm, there is a problem that the impregnation efficiency of an ion conductor is lowered and this results in a decrease in membrane yield. When it exceeds 100 μm, impregnation of an ion-conductive polymer becomes difficult and this may lead to a reduction in proton conductivity and deterioration of membrane performance.

The porosity of the porous support 5 may be from 40 to 95%, for example, from 50 to 90%, and preferably from 55 to 85%. When the porosity of the porous support 5 is less than 40%, the impregnation rate of an ion conductor may decrease, which may lead to a decrease in membrane performance, and when it exceeds 95%, the durability of a reinforced composite membrane may not be sufficiently secured.

The reinforced composite membrane 10 may be formed by impregnating the ion conductor into the porous support 5, or by forming an electrolyte layer 1 and/or 3 including the ion conductor on at least one surface of the porous support 5.

When the ion conductor is impregnated into the porous support 5, a mixed solution is produced by dispersing the ion conductor in a solvent, and then the porous support 5 is immersed in the mixed solution, whereby it is possible to form a reinforced composite membrane in which the ion conductor is impregnated in the porous support 5. The solvent may be water, a hydrophilic solvent, an organic solvent, or a mixed solvent of two or more thereof.

In the case of the reinforced composite membrane 10 in which the electrolyte layer 1 and/or 3 including the ion conductor is formed on at least one surface of the porous support 5, the reinforced composite membrane may be formed through a process of applying a mixed solution of the ion conductor on at least one surface of the porous support 5 and drying it, or of casting the mixed solution and drying it to form an electrolyte membrane including the ion conductor and then laminating it with at least one surface of the porous support 5.

Alternatively, the reinforced composite membrane 10 may include a configuration in which the electrolyte layer 1 and/or 3 is formed by laminating an electrolyte membrane including an ion conductor on at least one surface of the porous support 5 impregnated with the ion conductor.

The drying may be performed by applying heat of about 60° C. to 120° C. for 1 to 30 minutes, or preferably, by applying heat of about 70° C. to 100° C. for 5 to 15 minutes.

The reinforced composite membrane 10 according to an embodiment includes a structure in which an ion conductor is continuously distributed in the thickness direction of the reinforced composite membrane 10 from the surface of the porous support 5 because the porous support 5 is impregnated with an ion conductor or the electrolyte layer 1 and/or 3 including an ion conductor is provided on at least one surface of the porous support 5, thereby having continuity in ion conductivity.

The ion conductor can be used without particular limitation as long as it is generally used as a proton conductor in electrolyte membranes fuel cells, and specifically, a fluorinated polymer, a hydrocarbon-based polymer, or a mixture thereof, which is excellent in proton conductivity, cost-effective, and soluble in organic solvents, may be used.

In detail, it is preferable to use a polymer having an ion exchange capacity (IEC) of 0.8 meq/g or more as the ion conductor. A reinforced composite membrane, in which a polymer having such a high ion exchange capacity is impregnated in a porous support, can have excellent ion conductivity, strength, and dimensional stability.

The ion conductor may be selected from a group consisting of fluorinated polymers including poly(perfluorosulfonic acid), poly(perfluorocarboxylic acid), copolymers of tetrafluoroethylene and fluorovinyl ether containing sulfonic acid groups, defluorinated sulfur-containing polyether ketones, or mixtures thereof; sulfonated polymers including sulfonated polyimide (S-PI), sulfonated polyarylethersulfone (S-PAES), sulfonated polyetheretherketone (SPEEK), sulfonated polybenzimidazole (SPBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyethersulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, or mixtures thereof; and hydrocarbon polymers and mixtures thereof.

The method for manufacturing a polymer electrolyte membrane of the present disclosure further includes a step of printing a composition for printing that contains a functional additive on one surface or both surfaces of a polymer electrolyte membrane as described above, by using a digital printing device.

For the oxidative durability of a polymer electrolyte membrane, introduction of a functional additive 7′, for example, an antioxidant, is important, and, in the related art, as shown in (b) of FIG. 1, the functional additive 7′ was mixed with an ion conductor and uniformly distributed over the entire surface of the polymer electrolyte membrane, or, if necessary, as shown in (c) of FIG. 1, distributed only on one side of the electrolyte membrane 1. However, an antioxidant reaction of the antioxidant 7′ starts at an electrode catalyst layer, which is the origin of radical production, and therefore, it is necessary to distribute the functional additive 7′ on the surface contacting the electrode catalyst layer. However, with coating methods of the related art, it was difficult to apply the functional additive 7′ thinly and uniformly on one surface of an electrolyte membrane or to micropattern it.

In the present disclosure, by using digital printing technology, a functional additive could be uniformly applied onto the surface of a polymer electrolyte membrane, thereby enabling a removal reaction of hydrogen peroxide or radicals to occur on the surface of the polymer electrolyte membrane that is in contact with an electrode catalyst layer, and allowing a smaller amount of the functional additive to be used compared to the related art.

Accordingly, according to an embodiment of the present disclosure, there is provided a method for manufacturing a polymer electrolyte membrane that includes:

preparing a composition for printing that contains a functional additive; and forming a digital print layer by printing the composition for printing on one side or both sides of the polymer electrolyte membrane by using a digital printing device.

In this case, the polymer electrolyte membrane may be a reinforced composite membrane including a porous support and an ion conductor as described above, or may be a single membrane including an ion conductor.

The functional additive may be an optional additive that is added to improve characteristics such as the performance or durability of a polymer electrolyte membrane, and one type of functional additive may be used, or two or more types of functional additives may be mixed and used. Preferably, the functional additive may be an antioxidant.

The antioxidant may include at least one particle capable of removing peroxides or radicals that cause degradation of an electrolyte membrane and reduce its ion conductivity, and selected from a group consisting of transition metals, noble metals, their ions, their salts, their oxides, their nitrides, and their complexes.

The transition metal may be one or more selected from a group consisting of cerium (Ce), manganese (Mn), tungsten (W), cobalt (Co), vanadium (V), nickel (Ni), chromium (Cr), zirconium (Zr), yttrium (Y), iridium (Ir), iron (Fe), titanium (Ti), molybdenum (Mo), lanthanum (La), and neodymium (Nd), but is not limited thereto.

The noble metal may be one or more selected from a group consisting of silver (Ag), platinum (Pt), ruthenium (Ru), palladium (Pd), and rhodium (Rh), but is not limited thereto.

The ions of the transition metal or noble metal may be cerium (Ce) ion, manganese (Mn) ion, tungsten (W) ion, cobalt (Co) ion, vanadium (V) ion, nickel (Ni) ion, chromium (Cr) ion, zirconium (Zr) ion, yttrium (Y) ion, iridium (Ir) ion, iron (Fe) ion, titanium (Ti) ion, molybdenum (Mo) ion, lanthanum (La) ion, or neodymium (Nd) ion, and specifically, as an example of cerium, the ions may be cerium trivalent ions (Ce3+) or cerium tetravalent ions (Ce4+).

The salts of the transition metal or noble metal may be carbonates, acetates, chlorides, fluorides, sulfates, phosphates, nitrates, tungstates, hydroxides, ammonium acetates, ammonium sulfates, or acetylacetonates, and specifically, as an example of cerium, cerium carbonate, cerium acetate, cerium chloride, cerium acetate, cerium sulfate, diammonium cerium acetate, tetraammonium cerium sulfate, and the like can be mentioned, and as an organometallic complex salt, cerium acetylacetonate can be mentioned.

In the composition for printing, the functional additive can be contained at a concentration of 0.1 to 20 wt %, specifically at a concentration of 0.5 to 10 wt, on the basis of the total weight of the composition. By setting the additive concentration within the above range, the function of the functional additive can be sufficiently exhibited and it is possible to prevent problems such as a prolonged drying time of the membrane or difficulty in handling the composition.

The composition for printing may further contain a solvent. Accordingly, the method may further include a step of drying after forming the digital print layer. The solvent may be an aqueous solvent, for example, an alcohol-based solvent such as ethanol, propyl alcohol, or butyl alcohol. Further, the solvent may be a single solvent or a mixed solvent composed of two or more types of solvents. According to an embodiment of the present disclosure, the solvent may be a mixed solvent including two or more types of alcohols. The solvent preferably has a low boiling point to facilitate evaporation after printing, and for example, it is preferable to use ethanol. When using a mixed solvent, it is preferable to use a higher amount of a solvent with a lower boiling point from the viewpoint of ease of evaporation after printing, and for example, a mixed solvent in which propyl alcohol and ethanol are mixed at a weight ratio of 6:4 to 2:8 may be used. When using a solvent with a high boiling point, evaporation and drying are not easy, so there is a possibility that stains remain or pattern omission occurs after drying. The drying method is not particularly limited and may be performed by leaving at room temperature or by heating.

The composition for printing is printed onto one surface or both surfaces of the polymer electrolyte membrane by using a digital printing device, whereby a digital print layer can be formed.

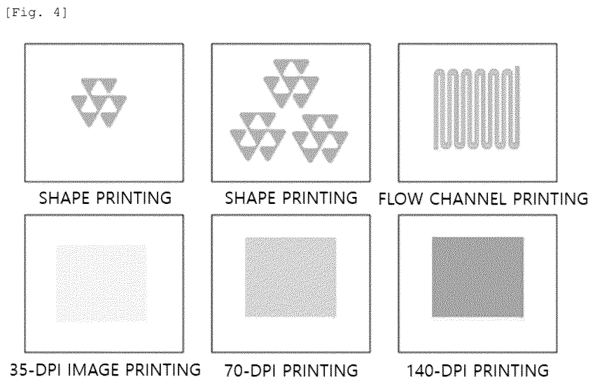

The composition for printing is printed in an arbitrary pattern, whereby a patterned digital print layer can be formed. Therefore, according to an embodiment of the present disclosure, the manufacturing method of the present disclosure may further include a step of designing the pattern image of the digital print layer using computer software and a step of transmitting the pattern image to a printer, so the composition for printing can be printed on the polymer electrolyte membrane in a pattern corresponding to the designed pattern image. The pattern is not particularly limited and may be various patterns as shown in FIG. 4, for example, a flow channel pattern or a dot pattern. In the present disclosure, by using digital printing, even very fine patterns can be accurately and easily achieved.

Further, the step of designing the pattern image of the digital print layer further includes a step of setting the resolution of the pattern image, and the printing amount of the composition for printing may be determined in accordance with the resolution. For example, the lower part of FIG. 4 shows results of printing digital print layers having the same area and the same pattern with different image resolutions of 35 dpi, 70 dpi, and 140 dpi, respectively. Black pigment of the same content was added to visually observe the layer, and it can be seen that the color gradually darkens as the resolution increases. Accordingly, the content of a functional additive in the same area or pattern can be easily adjusted, for example, doubled or quadrupled in accordance with the resolution.

The digital printing device may include a printer selected from a group consisting of an inkjet printer, a laser printer, an aerosol printer, and a thermal transfer or sublimation printer, and the composition for printing may be printed by the printer. For example, an inkjet printer may be used, and in this case, the inkjet printer may include piezo-type Drop-On-Demand inkjet printing using a piezoelectric element, thermal-type Drop-On-Demand inkjet printing using a microheater, Drop-On-Demand inkjet printing in which an actuator is driven by electrostatic force, and electrostatic inkjet printing (Electro-Static Deposition) in which charged particles dispersed in ink are transferred to a substrate or the ink itself is transferred to a substrate using electrostatic force.

Further, according to another aspect of the present disclosure, there is provided a method for manufacturing a membrane-electrode assembly including a step of bringing a polymer electrolyte membrane and an electrode into contact with each other such that a digital print layer of the polymer electrolyte membrane manufactured by the above-described manufacturing method according to the present disclosure faces the electrode. The method for manufacturing a membrane-electrode assembly may be performed in accordance with general methods except that the digital print layer of the polymer electrolyte membrane faces the electrode, and is not particularly limited.

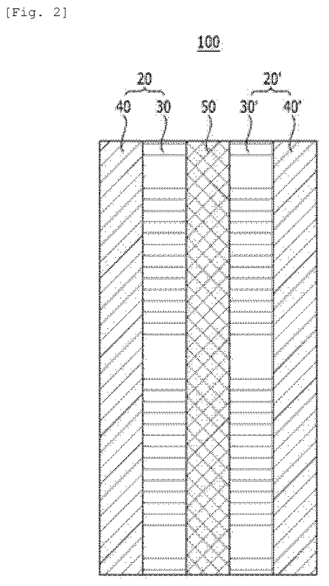

FIG. 2 is a schematic cross-sectional view illustrating a membrane-electrode assembly. Referring to FIG. 2, the membrane-electrode assembly 100 includes the reinforced composite membrane 50 and fuel cell electrodes 20 and 20′ respectively disposed on both surfaces of the reinforced composite membrane 50. The electrodes 20 and 20′ include electrode substrates 40 and 40′ and catalyst layers 30 and 30′ formed on the surfaces of the electrode substrates 40 and 40′, and may further include, between the electrode substrates 40 and 40′ and the catalyst layers 30 and 30′, a microporous layer (not shown) including conductive fine particles such as carbon powder or carbon black, to facilitate material diffusion in the electrode substrates 40 and 40′.

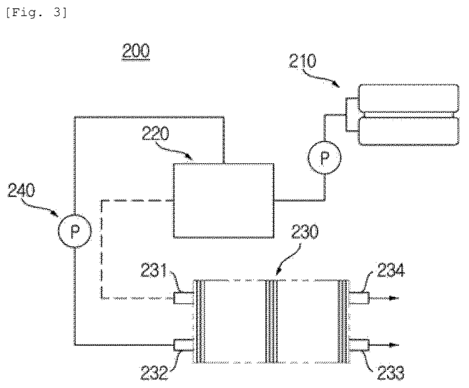

FIG. 3 is a schematic diagram illustrating the overall configuration of a fuel cell.

Referring to FIG. 3, the fuel cell 200 includes a fuel supply unit 210 that supplies a mixed fuel in which fuel and water are mixed, a reforming unit 220 that generates a reformate gas containing hydrogen gas by reforming the mixed fuel, a stack 230 that generates electrical energy by causing the reformate gas containing hydrogen gas and supplied from the reforming unit 220 to undergo an electrochemical reaction with an oxidant, and an oxidant supply unit 240 that supplies an oxidant to the reforming unit 220 and the stack 230.

The stack 230 includes a plurality of unit cells that generates electrical energy by inducing an oxidation-reduction reaction between a reformate gas including hydrogen gas and supplied from the reforming unit 220 and an oxidant supplied from the oxidant supply unit 240.

Each unit cell refers to a cell unit that generates electricity, and includes the membrane-electrode assembly, which induces oxidation and reduction of the reformate gas containing hydrogen gas and oxygen in the oxidant, and a separator plate (also referred to as a bipolar plate;

hereinafter referred to as “separator plate”) for supplying the reformate gas containing hydrogen gas and the oxidant to the membrane-electrode assembly. The separator plates are disposed on both sides with the membrane-electrode assembly therebetween. In this case, the separator plates positioned at both outermost sides of the stack are particularly referred to as end plates.

Among the separator plates, the end plate includes a pipe-shaped first supply pipe 231 for injecting reformate gas containing hydrogen gas and supplied from the reforming unit 220, and a pipe-shaped second supply pipe 232 for injecting oxygen gas, and the other end plate includes a first discharge pipe 233 for discharging to the outside the reformate gas containing unreacted hydrogen gas remaining in the plurality of unit cells, and a second discharge pipe 234 for discharging to the outside the oxidant remaining ultimately unreacted in the unit cells.

### MODE FOR INVENTION

Hereafter, specific embodiments of the present disclosure are provided. However, the embodiments described below are merely intended to exemplify or describe the present disclosure in detail, and the present disclosure is not limited thereto. Further, contents not described herein are those that can be technically inferred by those skilled in the art, and thus, their descriptions are omitted.

### Producing Example 1: Production of Composition for Printing

Cerium nitrate, as an antioxidant, was added to a mixed solvent of nPA (n-propyl alcohol) and ethanol as solvents such that the antioxidant concentration became 5 wt %. Further, a small amount of black ink was added to make visual observation easier after layer formation. The antioxidant was dispersed by ultrasonically treating the mixture, thereby producing a composition for printing. In this case, mixed solvents with weight ratios of 3:7 or 7:3 were prepared and used for the mixed solvent, and accordingly, two types of compositions for printing were prepared.

### Producing Example 2: Formation of Digital Print Layer

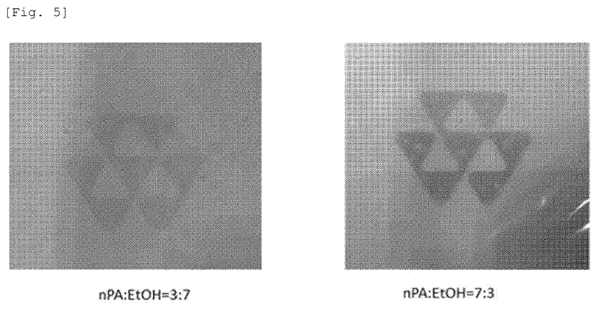

A digital image of 5 cm×5 cm (140 dpi resolution) was set, and the compositions for printing prepared in Producing Example described above were printed and dried on the surface of a fluorine-based reinforced composite membrane using an inkjet printer having 256-head nozzles, thereby forming a digital print layer. FIG. 5 illustrates the digital print layer. When the nPA: EtOH ratio is 7:3, where a relatively higher amount of nPA with a higher boiling point is present, evaporation after coating is difficult, so it can be seen that stains and uncoated areas occur on the membrane surface after printing. On the other hand, when the nPA: EtOH ratio is 3:7, where a relatively higher amount of EtOH with a lower boiling point is present, it can be seen that the coating is uniformly formed without stains or spreading due to a faster drying characteristic after printing.

### Embodiment 1: MEA Including Polymer Electrolyte Membrane According to Present Disclosure (Structure of (d) in FIG. 1)

Using the composition for printing of Producing Example 1 with an nPA:EtOH ratio of 3:7, a 5 cm×5 cm square image was digitally printed on one side of a reinforced composite membrane having a thickness of 20 μm, thereby producing a reinforced composite polymer electrolyte membrane having the structure shown in (d) of FIG. 1. In this case, the resolution of the digital image was set to 140 dpi, and according to this resolution, the content of the antioxidant in the polymer electrolyte membrane was 7 μg/cm². The digitally printed antioxidant side was designated as a reduction electrode side and a membrane-electrode assembly (MEA) having an area of 5 cm×5 cm was manufactured.

### Comparative Example 1: MEA Including Polymer Electrolyte Membrane Without Antioxidant (Structure of (a) in FIG. 1)

An MEA was manufactured in the same manner as in Embodiment 1, except that a reinforced composite polymer electrolyte membrane having the structure shown in (a) of FIG. 1 and containing no antioxidant was used.

### Comparative Example 2: MEA Including Polymer Electrolyte Membrane in Which Antioxidant Is Uniformly Distributed (Structure of (b) in FIG. 1)

An MEA was manufactured in the same manner as in Example 1, except that a reinforced composite polymer electrolyte membrane having the structure shown in (b) of FIG. 1 was used, which was manufactured using cerium nitrate as an antioxidant such that the antioxidant content in the polymer electrolyte membrane was 12 μg/cm².

### Experimental Example: Evaluation of Cell Performance and Durability

A performance and accelerated durability evaluation of unit cells was conducted using the MEAs manufactured in Embodiment 1, Comparative Example 1, and Comparative Example 2. Cell performance was compared by measuring the current density value (A/cm²) at a voltage of 0.65 V under a humidified condition of 65° C. and 50% RH, and in order to evaluate chemical durability resulting from the additive, the Open Circuit Voltage (OCV) degradation time was measured under a cell operation condition of 90° C. and 30% RH. The OCV degradation time was compared on the basis of the time taken for the OCV value to degrade to 20% of the initial OCV value. The results are shown in the following Table 1.

TABLE 1

| | | | | | OCV |
|---|---|---|---|---|---|
| | Membrane | Additive | | Cell | Degradation |
| Classification | Thickness | Content | | Performance | time |
| Comparative | 20 ± 2 μm | 0 | μg/cm² | 0.93 A/cm² | 310 hr |
| Example 1 | | | | | |
| [(a) of FIG. 1] | | | | | |
| Comparative | 20 ± 2 μm | 12 | μg/cm² | 0.90 A/cm² | 585 hr |
| Example 2 | | | | | |
| [(b) of FIG. 1] | | | | | |
| Embodiment 1 | 20 ± 2 μm | 7 | μg/cm² | 0.91 A/cm² | 510 hr |
| [(d) of FIG. 1] | | | | | |

It can be seen that, as shown in Table 1, Comparative Example 1 without any additive exhibited an OCV accelerated durability time of 310 hours, and in Comparative Example 2, where a certain amount of additive was uniformly distributed in the reinforced membrane, the cell performance slightly decreased, but the OCV chemical durability time improved to 585 hours. However, it can be seen that, in the case of the MEA of Embodiment 1, in which 7 μg/cm² of additive was applied to the junction surface on the cathode side of the reinforced membrane by digital printing, the cell performance was comparable to that of Comparative Example 1 and the OCV chemical durability time improved to 510 hours. Furthermore, it can be seen that despite using a significantly smaller amount of additive (nearly half) in comparison to Comparative Example 2, cell performance and durability comparable to Comparative Example 2 was exhibited.

1. A method for manufacturing a polymer electrolyte membrane, the method comprising:
preparing a composition for printing, containing a functional additive; and
forming a digital print layer by printing the composition for printing on one side or both sides of the polymer electrolyte membrane by using a digital printing device.

2. The method of claim 1, wherein the functional additive is an antioxidant removing peroxides or radicals.

3. The method of claim 2, wherein the antioxidant is at least one selected from a group consisting of transition metals, noble metals, ions thereof, salts thereof, oxides thereof, nitrides thereof, and complexes thereof.

4. The method of claim 2, wherein the antioxidant comprises at least one or more transition metals selected from a group consisting of cerium (Ce), manganese (Mn), tungsten (W), cobalt (Co), vanadium (V), nickel (Ni), chromium (Cr), zirconium (Zr), yttrium (Y), iridium (Ir), iron (Fe), titanium (Ti), molybdenum (Mo), lanthanum (La), and neodymium (Nd).

5. The method of claim 1, wherein the functional additive is contained at a concentration of 0.1 to 20 wt % in the composition for printing on the basis of a total weight of the composition.

6. The method of claim 1, wherein the composition for printing further contains a solvent, and the method further comprises drying after forming the digital print layer.

7. The method of claim 6, wherein the solvent is a mixed solvent comprising two or more types of alcohols.

8. The method of claim 7, wherein the solvent is a mixed solvent in which propyl alcohol and ethanol are mixed at a weight ratio of 6:4 to 2:8.

9. The method of claim 1, wherein the digital printing device comprises a printer selected from a group consisting of an inkjet printer, a laser printer, an aerosol printer, and a thermal transfer or sublimation printer, and the composition for printing is printed by the printer.

10. The method of claim 1, further comprising designing a pattern image of the digital print layer using computer software, and transmitting the pattern image to a printer, wherein the composition for printing is printed on the polymer electrolyte membrane in a pattern corresponding to the pattern image.

11. The method of claim 10, wherein the designing of a pattern image of the digital print layer further comprises setting resolution of the pattern image, and a printing amount of the composition for printing is determined in accordance with the resolution.

12. The method of claim 1, wherein the polymer electrolyte membrane is a reinforced composite membrane comprising a porous support and an ion conductor.

13. A method for manufacturing a membrane-electrode assembly, the method comprising bringing the polymer electrolyte membrane manufactured in accordance with claim 1 into contact with an electrode such that the digital print layer of the polymer electrolyte membrane faces the electrode.
